(19) United States
(12) Patent Application Publication
(10) Pub. No.: US 2020/0258362 A1
(43) Pub. Date: Aug. 13, 2020

(54) SMOKE DETECTION MATERIAL, METHOD, APPARATUS AND KIT

(71) Applicant: Jonathan L. Liss, Columbus, GA (US)

(72) Inventors: Jonathan L. Liss, Columbus, GA (US); Daniel Richard Morrison, Athens, GA (US); Richard William Morrison, Athens, GA (US); Douglas Michael Jackson, Athens, GA (US)

(73) Assignee: Jonathan L. Liss, Columbus, GA (US)

(21) Appl. No.: 16/761,258

(22) PCT Filed: Nov. 3, 2018
(86) PCT No.: PCT/US2018/059110

§ 371 Date: May 3, 2020

Related U.S. Application Data
(60) Provisional application No. 62/581,619, filed on Nov. 3, 2017.

(51) Int. Cl. G08B 17/117; G01N 21/78; G01N 31/22

(52) U.S. Cl. CPC G08B 17/117; G01N 31/22; G01N 21/783

(57) ABSTRACT

A smoke detection apparatus comprises an enclosure defining a reaction compartment therein and a detection element disposed within the reaction compartment. The detection element comprises a porous gel material and a detection compound. A backing may retain the material. The detection material being configured to react with at least one component of tobacco smoke, to undergo a color change visible to an unaided human eye from a viewpoint external to the enclosure. A smoke detection kit comprises enclosure defining a reaction compartment therein and a multiplicity of detection elements, each including a detection material. A method of preparing a detection material comprises mixing a metal oxide monomer with a dye in presence of a solvent to form a gel and drying the gel, wherein the dye is located in pores of the dried gel and is configured to undergo a color change in the presence of volatile amine compounds.

### RELATED APPLICATIONS

This application claims the benefit of U.S. Provisional Application No. 62/581,619 filed Nov. 3, 2017, the content of which is incorporated by this reference its entirety for all purposes as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to materials, methods, apparatuses and kits for detecting smoke. More particularly, the disclosure relates to materials, methods, apparatuses and kits for detecting one or both of tobacco and marijuana smoke in an occupiable space.

### BACKGROUND

Tobacco and marijuana smoke are known hazards to the smoker and individuals around the smoker. Stains, odors and other harmful effects often linger where the smoking took place. This is of particular concern for the rental industry such as hotels, motels and automobile rental agencies, which have historically struggled with deterring and mitigating the effects of smoking. To date, development and implementation of effective measures against smoking have remained a challenge.

### SUMMARY

In an exemplary embodiment, a smoke detection apparatus comprises an enclosure defining a reaction compartment therein. A detection element may be disposed within the reaction compartment. The detection element may include a detection material comprising a porous gel material and a detection compound. The detection compound may be configured to react with at least one component of tobacco or marijuana smoke, and thereby undergo a color change visible to an unaided human eye from a viewpoint outward of the enclosure.

A smoke detection kit may comprise an enclosure defining a reaction compartment therein, and a multiplicity of detection elements. Each detection element may (a) be configured to be disposed within the reaction compartment, and (b) include a detection material comprising a porous gel material and a detection compound. The detection compound may be configured to react with at least one component of tobacco or marijuana smoke, and thereby undergo a color change visible to an unaided human eye from a viewpoint outward of the enclosure.

In an exemplary embodiment, a method of preparing a detection material may comprise (a) mixing a metal oxide monomer with a dye in presence of a solvent to form a gel, and (b) drying the gel. The dye may be located in pores of the dried gel and is configured to undergo a color change in the presence of volatile amine compounds.

In an exemplary embodiment, a smoke detection element comprises a detection material, and a detection material backing configured to retain the detection material. The detection material may comprise a detection compound located within the pores of a porous gel material. The detection compound may be configured to react with at least one component of tobacco or marijuana smoke, so as to undergo a color change that is visible to an unaided human eye.

In preferred embodiments of the smoke detection apparatus, detection material, and kit, the detection compound may be configured to react to one or both of tobacco and marijuana smoke.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of one example of a smoke detection apparatus in accordance with the present disclosure;

FIG. 2A is a diagrammatic side view of an example smoke detection apparatus shown mounted to a mounting surface, such as a wall or window, by way of an example enclosure mounting element;

FIG. 2B is a is a diagrammatic side view of a further example smoke detection apparatus shown mounted to a mounting surface, such as an air return vent of an air conditioning system in a room or vehicle;

FIG. 3 is a diagrammatic exploded view of an example smoke detector apparatus similar to that shown in FIG. 1;

FIG. 4 is a diagrammatic perspective view of a cover portion from the example apparatus shown in FIG. 3;

FIG. 5 is a diagrammatic perspective view of the apparatus of FIG. 3 in partially-assembled configuration;

FIG. 6A is a diagrammatic perspective view of one example enclosure with the cover portion and base portion in closed configuration;

FIG. 6B is a diagrammatic cross-sectional view of an example smoke detection apparatus, illustrating the use of zip ties as tamper-proofing elements;

FIG. 7A is a diagrammatic side view of an example enclosure in which the cover portion and base portion are unitarily formed in an injection molding process so as to be adjoined by a living hinge, shown in an open configuration;

FIG. 7B is a diagrammatic side view of an example smoke detection apparatus using the enclosure shown in FIG. 7A, but wherein the enclosure is shown retained in a closed configuration by the living hinge and mutually-engaging closure elements, and heat shrink polymer wrapping envelopes at least a portion of the enclosure to aid in securement and tamper-proofing;

FIG. 8 is a diagrammatic side view of an alternative example of a smoke detection apparatus and kit, including an auxiliary lens element;

FIG. 9A is a diagrammatic cross-sectional view of an example smoke detection apparatus mounted to a mounting surface, and including an example tamper indicator flag with the flag portion being in a display position outward of the enclosure, thereby indicating that the apparatus has not been removed from the mounting surface;

FIG. 9B is a diagrammatic cross-sectional view of an example smoke detection apparatus similar to that of FIG. 9A, but wherein removal of the enclosure from the mounting surface has caused the flag portion to be pulled from its display position so as to indicate such removal has occurred;

FIG. 9C is a diagrammatic cross-sectional view similar to that of FIG. 9A, but wherein the adhesive mounting strip has remained on the mounting surface when the apparatus was removed from the mounting surface;

FIG. 10 is a diagrammatic front view of a smoke detection apparatus applied (mounted) to a transparent mounting surface, showing the tamper indication markings imbedded in the adhesive mounting strips and viewable through the mounting surface;

FIG. 11A is a diagrammatic cross-sectional view of one example detection element, illustrating a detection material on a detection backing, with a peelably-removable preservation film disposed over the detection material;

FIG. 11B is a diagrammatic cross-sectional view of one example stack of detection elements, as might be included with a smoke detection kit in accordance with the present disclosure;

FIG. 12 is a table listing commercially-available dyes that yield a visible color change to analytes H2S, NH3 and HCN;

FIGS. 13A and 13B illustrate the chemical structure of bromocresol green and bromocresol purple, respectively, and the observed color change at various pH levels;

FIG. 13C illustrates the chemical structure of iodophenol blue;

FIG. 14 is table showing the response of doped gels to various indoor sources of volatile compounds;

FIG. 15 is a table showing the color change of doped gels in presence of cigarette smoke;

FIG. 16 is a table showing the stability of doped gels observed over a period of time;

FIG. 17 is a table showing the durability of doped gels observed over a period of time;

FIG. 18 is a table showing the effects of backing material on doped gels;

FIG. 19 is a table showing the results of smoke testing doped gels with filters;

FIG. 20 illustrates results of gels expure to smoke and glass cleaner;

FIG. 21 is another illustration of the results of gels exposure to smoke and glass cleaner; and

FIG. 22. Illustrates results of exposure of aged gels to smoke.

### DETAILED DESCRIPTION OF THE PREFERRED EMBODIMENTS

The present disclosure presents smoke detection materials, apparatuses, kits, and methods for manufacture thereof which aid in determining the presence of tobacco or marijuana smoke in commercial and residential environments. Specifically, the exemplary embodiments enable detection of tobacco or marijuana smoke in an enclosed occupiable space. As used herein, “occupiable space” broadly denotes any space occupiable by a human. Examples include, but are not limited to, bedrooms, living rooms, hallways, garages, bathrooms, laundry rooms, attics, closets, automobile passenger compartments, bus cabins, train cabins, airplane cabins, boat cabins, elevators, or other such similar spaces. In exemplary embodiments, the occupiable space is an enclosed space. Moreover, while the exemplary embodiments of smoke detection materials, apparatuses, kits, and methods are described with reference to tobacco and marijuana smoke detection, the present disclosure contemplates detection of smoke 156 from a variety of smoking devices 154 which burn leafy plants producing similar volatile compounds to tobacco or marijuana.

Exemplary embodiments of a smoke detection apparatus 100 may be configured to detect tobacco or marijuana smoke 156 in an occupiable space. A smoke detection apparatus 100 may preferably comprise an enclosure 102 and a detection element 110. The enclosure 102 may preferably define a reaction compartment 108 therein. In exemplary embodiments, the enclosure may be constructed from essentially any material suitable for housing the detection element. In an exemplary embodiment, the housing comprises a biodegradable material, such as a polyester or polyamide. In a non-limiting example, the housing comprises polyhydroxyalkynoate polymer. The detection element 110 may be disposed within the reaction compartment 108, and may include a detection material 112 comprising a porous gel material and a detection compound. The detection compound may be configured to react with at least one component of tobacco or marijuana smoke 156, and thereby undergo a color change visible to an unaided human eye from a viewpoint 162 outward of the enclosure 102.

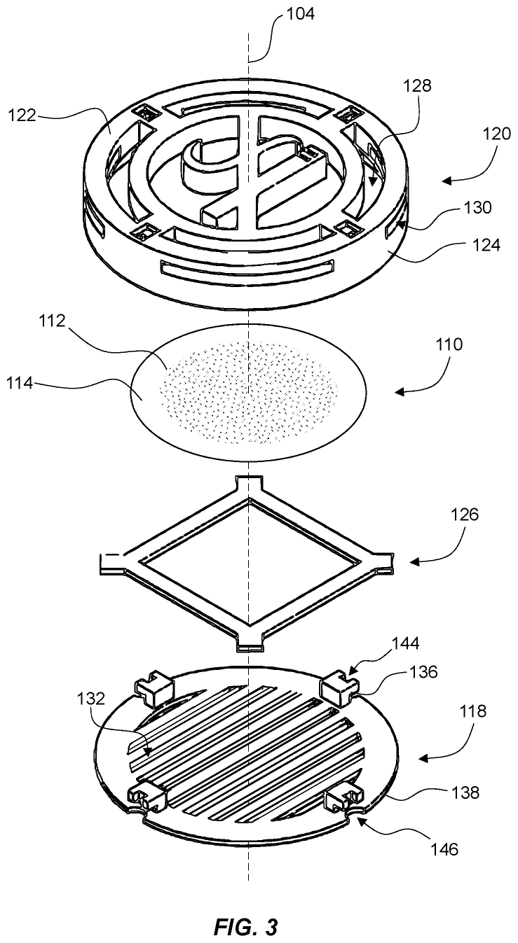

The reaction compartment 108 is typically in airflow communication with an ambient environment 106 surrounding the enclosure 102. Such airflow communications may be provided by one or more vents extending from the outer surface of the enclosure 102 into the reaction compartment 108. With reference to FIG. 3, these vents may take the form of, for example, one or more cover vent apertures 128, lateral vent apertures 130, base vent apertures 132, or some combination thereof. In certain implementations, a lateral vent aperture may be defined by a gap between the cover flange 124 of the cover portion 120, and the radial periphery 138 of the base portion 118. Such a gap may be axial or radial respect to the main axis 104.

The enclosure 102 may include a cover portion 120 and a base portion 118. The visibility of the color change may be by way of one or more windows 174 in the enclosure 102. A window 174 may perform the role of one of the aforementioned airflow vents. In the alternative, the window may be comprised of a transparent or translucent material, which may or may not be lensed for providing optical magnification of the detection element 110.

Referring to FIGS. 2A and 2B, a smoke detection apparatus 100 may be configured to be mounted to a solid surface (as in FIG. 2A), or a surface through which air is designed to flow, such as an air conditioning air return vent 164 in a room or vehicle (as in FIG. 2B). In FIG. 2A, the airflow 158 enters and exits the apparatus 100 primarily by way of the cover vent apertures and lateral vent apertures. In FIG. 2B, the airflow 158 is shown being drawn through the apparatus 100 and into the air return vent 164.

In particular embodiments of the apparatus 100, the cover portion 120 and the base portion 118 may be ultrasonically welded to one another so as to prevent removal of the detection element 110 from the reaction compartment 108 without such removal causing visible damage to the enclosure 102. Additionally, or in the alternative, a smoke detection apparatus 100 may further comprise a separate tamper-proofing element 152 to prevent the enclosure 102 from being opened without said opening causing visible damage to the enclosure 102 or the tamper-proofing element 152. The apparatus 100 may also include a signature plate 184 or the like, for the authorized installer of the apparatus to sign.

An enclosure mounting element 148 may be provided to facilitate mounting of the apparatus 100 to a mounting surface 160. The mounting element may be, for example, double-sided tape, hook-and-loop fastener, cable ties, a combination thereof, or the like.

Referring to FIGS. 7A and 7B, in certain embodiments of the apparatus 100, the cover portion 120 and the base portion 118 may be connected to one another by way of a living hinge 186. Such a configuration would allow the cover portion 120 and base portion 118 to be injection molded simultaneously, as a unitary piece. The cover portion 120 and base portion 118 may be retained in a closed configuration by way of the living hinge 186 and one or more mutually-engaged closure elements 188. Such closure elements may take the form of complementary (e.g., male-female) features that may be press-fit, snap-fit, adhered or ultrasonically welded together. At least portions of the mutually-engaged closure elements 188 may be configured to visibly fracture upon movement of the cover portion 120 and base portion 118 from the closed configuration to an open configuration. Alternatively, or in addition, the cover portion 120 and base portion 118 may be ultrasonically welded together along their radial peripheries.

Referring again FIG. 7B, in particular embodiments of the apparatus 100, the cover portion 120 and the base portion 118 may be retained in a closed configuration by way of a heat-shrink polymer wrapping 190. The heat shrink polymer wrapping may also serve to prevent, dissuade or indicate the occurrence of tampering with the assembled apparatus 100. Accordingly, the heat shrink polymer wrapping may act as a tamper proofing element 152.

Referring to FIGS. 3 and 5, a smoke detection apparatus 100 may further comprise a retention portion 126 disposed within the reaction compartment 108, to spatially retain the detection element 110 with respect to the enclosure 102. The retention portion 126 may be one-piece, or a plurality of pieces. For instance, where there are multiple distinct detection elements 110 in an apparatus 100, multiple retention portions 126 can be used. A single retention portion 126 may retain multiple detection elements 110 as well.

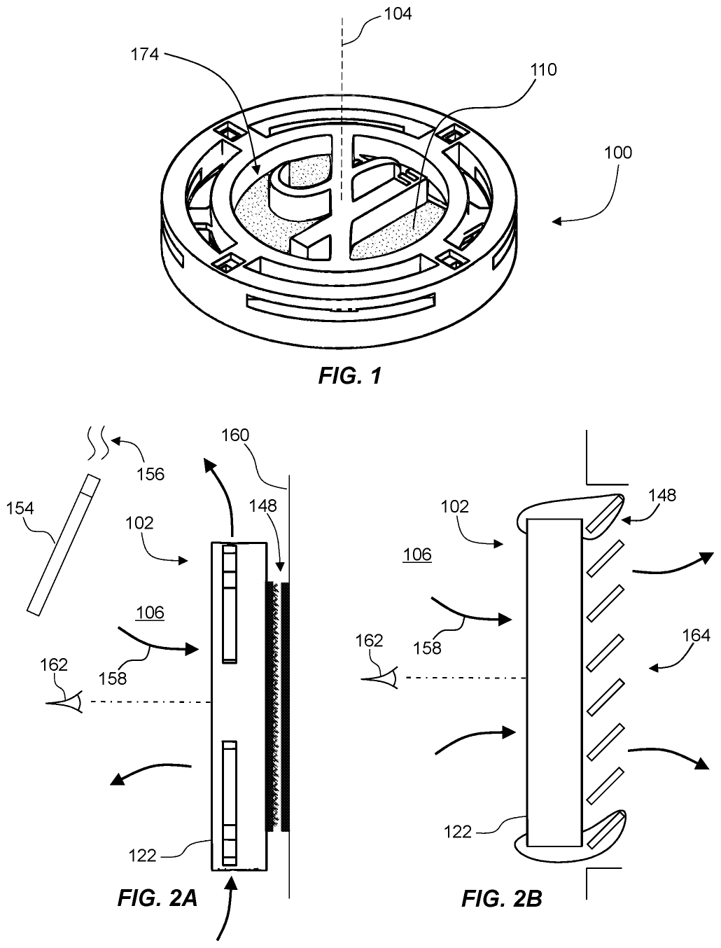

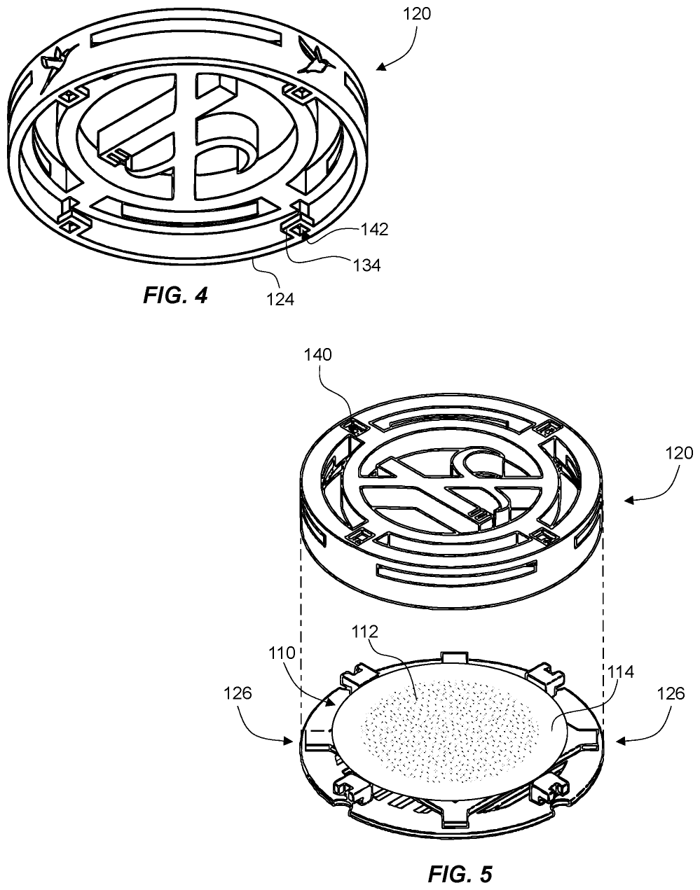

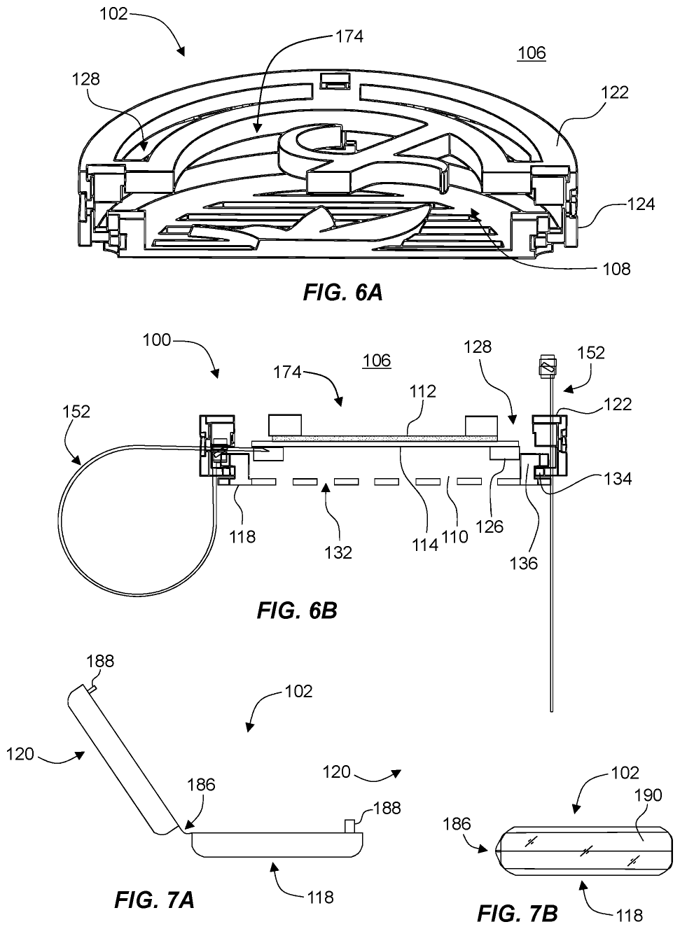

In particular embodiments of the apparatus 100, the cover portion 120 and base portion 118 may be mutually-engageable so as to retain them in a closed configuration with respect to one another. With reference to FIGS. 3-5, this mutual engagement may be by way of rotation of the cover portion 120 with respect to the base portion 118 about a main axis 104. For example, base detents 136 may be configured to engage with corresponding cover detents 134 upon rotation of the cover portion with respect to the base portion. See, for example, FIG. 6A. Moreover, the mutual engagement may be lockable by way of a tamper-proofing element, such as the zip ties 152 shown in FIG. 6B. A zip tie may also be referred to conventionally as a tie wrap or cable tie. In the apparatus illustrated in FIGS. 1, 3 and 5, a zip tie (or the like) 152 may extend through a forward lock aperture 140 in the cover face 122, a forward lock groove 144, and a rearward lock aperture 142 so as to prevent the base portion 118 from rotating with respect to the cover portion 120. A rearward lock groove 146 may provide clearance for the zip tie 152 to extend outward of the enclosure 102. The zip tie (tie wrap) may be coded with a unique identification, such as a color pattern or alpha-numeric code, so that an unauthorized party's replacement of the zip tie would be readily apparent as evidence of tampering with the apparatus 100.

In certain preferred embodiments of an apparatus 100, an adhesive mounting strip 176 may be disposed on the base portion 118 for mounting the enclosure 102 to a mounting surface 160. Further, with reference to FIGS. 9A-9C, a tamper indicator flag may be provided which may have, for example, an adhesion portion 178a , a flag portion 178b and an intermediate portion 178c therebetween. The adhesion portion 178a may be affixed to the adhesive mounting strip 176, with the intermediate portion 178c passing through the enclosure 102, and the flag portion 178b being in a displayed position outward of the enclosure 102 (see, for example, FIG. 9A). In such an embodiment, removal of the enclosure 102 from the mounting surface 160 causes the flag portion 178b to be pulled from its display position and into the enclosure (see, for example, FIGS. 9B and 9C), indicating that the mounting of the apparatus 100 to the mounting surface 160 was tampered with.at some point. With particular reference to the embodiment shown in FIGS. 9A-9C, the adhesion portion 178a may include two adhesion members, one adhesion member being disposed between the base portion 118 and the adhesive mounting strip 176, the other adhesion member being disposed on the adhesive mounting strip 176 oppositely of the base portion 118.

Referring to FIG. 10, in an apparatus 100 with an adhesive mounting strip 176, the adhesive mounting strip 176 may include a plurality of tamper indication markings 182 applied thereto or imbedded therein. When the smoke detection apparatus 110 is applied to a transparent or translucent mounting surface 180 (such as the windshield of a car or truck) by way of the adhesive mounting strip 176, the tamper indication markings 182 are visible from the side of the mounting surface 180 opposite the smoke detection apparatus 100. Accordingly, if the smoke detection apparatus 100 is removed from the mounting surface 180 and then replaced back thereon, the tamper detection markings will show damage. For example, the tamper indication markings 182 may be 201b paper dots that would exhibit damage if a blade were used to temporarily remove the adhesive mounting strip from the windshield.

In particular preferred embodiment of a smoke detection apparatus 100, the base portion 118 may include a break-away portion disposed between the adhesive mounting strip 176 and the remainder of the base portion 118. The break-away portion may be configured to break away (e.g., fracture) from the remainder of the base portion 118 when the enclosure 102 is pulled from a mounting surface 160 to which the enclosure is mounted by way of the adhesive mounting strip 176.

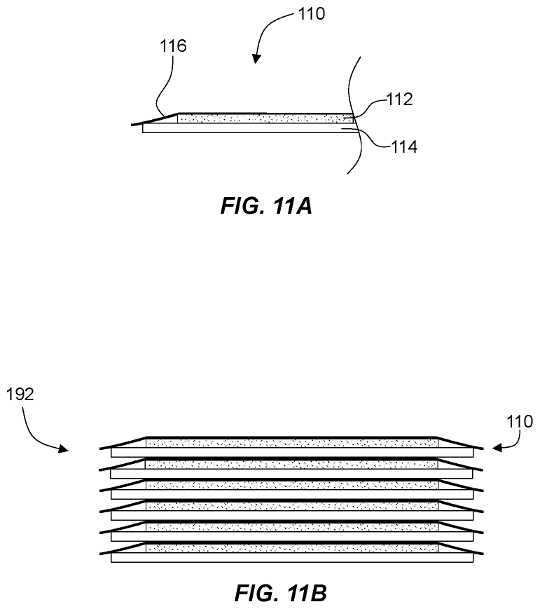

A smoke detection kit may comprise an enclosure 102 and a multiplicity of detection elements 110. The multiplicity of detection elements 110 may be arranged in a stacked configuration, as illustrated for example at 192 in FIG. 11B. Referring to FIG. 11A, the detection elements 110 may each include a removable preservation film 116 (e.g., a peelable layer) on the detection material 112.

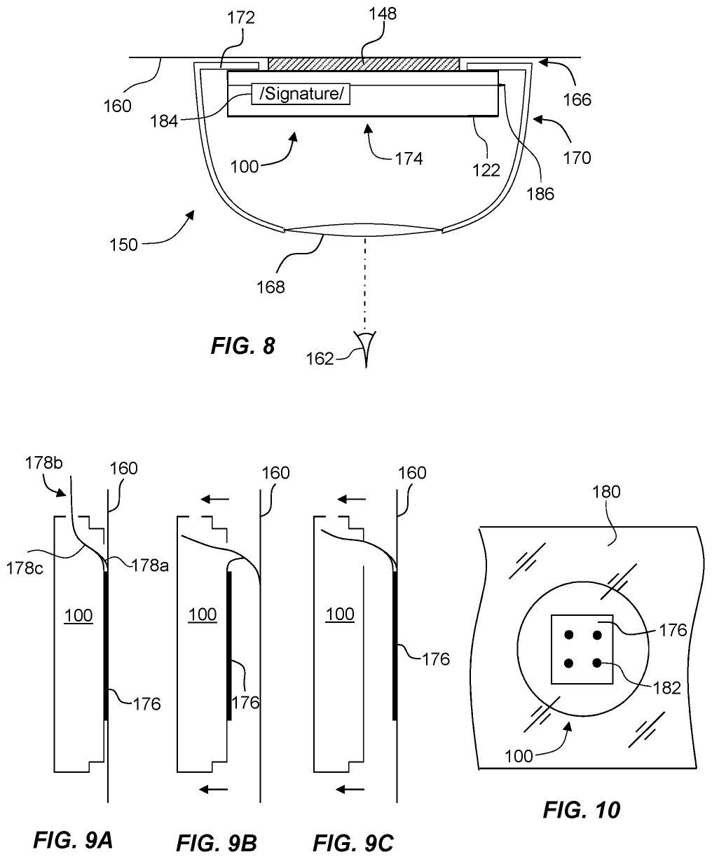

Referring to FIG. 8, certain embodiments of a smoke detection kit may further comprise an auxiliary lens element including a magnification lens 168, a grip portion 172, and a lens support element 170 disposed therebetween. The grip element 172 may be configured to engage the enclosure 102 and suspend the lens 168 therefrom at a fixed distance (e.g., 2-6 inches) from the enclosure 102 so as to optically magnify a detection element 110 disposed within the reaction compartment 108 from a viewpoint 162 outward of the lens 168. The grip element 172 may be, for example, annular or U-shaped, so as to envelop or otherwise engage an auxiliary mounting groove 166 for between the enclosure and a mounting surface 160, or formed in the periphery of the enclosure 102.

In particular, the apparatus comprises a detection element 110 and an enclosure 102. Here, the detection element preferably comprises a detection material 112 and may further comprise a detection material backing 114. The detection material 112 may be configured to react with at least one component of tobacco or marijuana smoke to undergo a color change that is visible to an unaided eye. As further described below, the detection material 112 can comprise a porous gel material and a detection compound.

The enclosure 102 is generally configured to retain the detection element in the reaction compartment and permit flow of air from an ambient environment into the reaction compartment. As used herein, “ambient environment” denotes air external to the enclosure 102. Thus, the air in the ambient environment 106 may comprise volatile substances or compounds in the smoke from tobacco or marijuana smoke, or other similar leaf plants. Accordingly, air flow in an occupiable space can provide flow of ambient environment air into the reaction compartment 108 such that components of tobacco or marijuana smoke contacts the detection material 112.

In particular embodiments of the apparatus 100, the enclosure 102 may comprise two or more reaction compartments 108. In such designs, the enclosure 102 may include multiple detection elements 110, windows 174 and vent apertures corresponding to each reaction compartment 108.

Further, the retention portion 126 may be positioned to optimize detection or visibility of color change. For instance, the configuration of the retention portion may allow positioning of the detection element relative to an enclosure vent or aperture to optimize the interaction of smoke and detection element. Similarly, the retention portion 126 may be positioned to place the detection element 110 at an optimally viewable angle with respect to an enclosure opening or window.

In an exemplary embodiment, the retention portion is adjustable. That is, it may be configured to be moved back and forth between at least two positions to facilitate certain functions. For example, the retention portion 126 may be spatially repositioned to permit a user to replace the detection element 110, clean the reaction compartment 108, or perform any other type of desired maintenance to the apparatus 100.

In the exemplary embodiments, the detection element comprises a detection material backing configured to retain the detection material. The shape of the backing material can vary to accommodate for the shape of the enclosure, shape of the detector element, configuration of the reaction compartment(s), or the configuration of any other element in the apparatus. The detection material backing may be flexible to conform to the shape of the detection material or rigid. Moreover, it may be curved or flat. In the examples provided in FIGS. 3, 5 and 6B, the detection material backing 114 is substantially flat.

Generally, any material may be suitable for the detection material backing 114 so long as it does not substantially interfere with detection of tobacco or marijuana smoke. Preferably the detection material backing 114 is inert to, or does not undergo substantial ion exchange with, the detection material 112. Suitable detection material backings include, but are not limited to, materials comprising a ceramic, porcelain, glass or plastic surface for retaining the detection material. In an exemplary embodiment, the backing comprises a biodegradable material, such as a polyester or polyamide. In a non-limiting example, the backing comprises polyhydroxyalkynoate polymer. The backing 114 may also be buffered to minimize interference with smoke detection. For example, the surface of the detection material backing 114 contacting the detector material 112 can be buffered at a pH of about 3.5 or less. Accordingly, an adhesive backing with a buffered surface may be used to retain the detain the detection material 112 without a false positive indication.

As discussed previously, a smoke detection apparatus 100 may comprise multiple detection elements 110 in one or more reaction compartments 108 of the enclosure 100. As such, a plurality of detection material backing pieces may be used. In such a case, each backing may be different based on the type of detection material, or function of the detection element. In some instances, one detection material backing may be used to retain a plurality of distinct detection materials. In such cases, the apparatus 100 may be regarded as comprising a plurality of detection elements 110.

The detection material 112 may be placed on the detection material backing 114 before or after the detection material is dried (drying further discussed below). For instance, the dried or partially dried detection material may be placed or dispersed on the detection material backing 114 in the form of a monolith, particles or powder. In some instances, the particulate or powder form may be compressed into a unitary piece with a desired shape. Preferably, the detection material 112 is securely retained by the detection material backing 114 without any adhesive.

In the exemplary embodiments the detection material 112 comprises a porous gel material and a detection compound. The gel material can be a porous sol-gel material. Advantageously, the sol-gel processing technique permits incorporation of the detection compound within the pores of the gel structure. As such, detection compounds of the exemplary embodiments incorporated in the pores of a dried gel material exhibit increased sensitivity to tobacco or marijuana smoke relative to their solution phase sensitivity. In this sense, the exemplary embodiments provide a detector device which is superior to merely using the indicator, in determining the presence of tobacco or marijuana smoke.

The sol-gel process, enables synthesis of detection materials comprising an organic, inorganic, or hybrid organic-inorganic porous gel structure. With this process, it is possible to form a porous framework around the trapped dye molecules thereby greatly increasing the stability of detection material and distributing the dye through three dimensions increasing its sensitivity. Advantageously, the dye molecules within the framework are accessible by small analyte molecules (e.g., volatile amine compounds such as ammonia) but not larger organics and pollutant particles. This technique can be used to prepare monolith, particulate or powder form of the detection material.

Moreover, pore size, pore distribution and surface area may be adjusted with the processing conditions and the relative reaction component concentrations. Accordingly, such sol-gel materials may be microporous, mesoporous, nanoporous or a combination thereof. Additionally, the dried gel material may be ground into powder form to increase surface area of the gel material. Modifying the physical properties of the gel material may advantageously increase the sensitivity or performance of the detection material. The preferred gel material in the exemplary embodiments is a silica gel.

Tobacco or marijuana smoke can be detected by reacting with one or more components of the smoke with a detection compound in the porous gel material, which undergoes a visible color change. Accordingly, in the exemplary embodiments, the detection compound is a dye configured to change color upon reacting with one or more components of tobacco or marijuana smoke. Such dyes can be pH indicator dyes which can reversibly or irreversibly undergo a color change.

In certain preferred embodiments of the apparatus 100, the dyes irreversibly produce a color change. In such embodiments, the entire apparatus 100 may be disposable, so that following a color change the apparatus 100 is simply replaced.

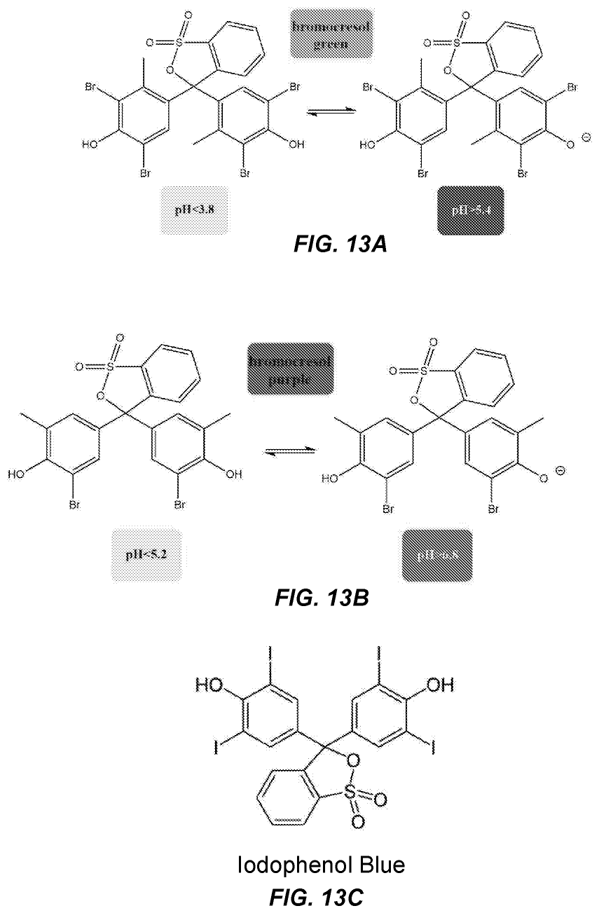

pH indicator dyes can refer to compounds whose acidic and basic form have markedly different colors in the visible range of the electromagnetic spectrum. bromocresol green and bromocresol purple for example have characteristic color changes at the ranges shown in FIGS. 13A and 13B. When the dyes are buffered to near equivalence, they will have their characteristic colors of green and reddish purple which are blends of the colors of the individual acidic and basic molecular forms. For example, when a raise in pH occurs, bromocresol green will become more blue and less yellow until only the blue color is visible. Iodophenol blue (FIG. 13C), bromocresol green (FIG. 13A) and bromocresol purple (FIG. 13B) among other such dyes can be sensitive to the presence of amines or other components of tobacco or marijuana while residing the in a sol gel matrix as further described in this disclosure.

Dyes present in the gel pores perform advantageously as detectors over the dye in solution. For instance, the pores can allow ammonia (from tobacco or marijuana smoke) to enter where it proton exchanges directly with the dye causing a structural change in the dye (e.g. bromocresol green). This is consistent with a direct change from the orange acidic form to the basic blue form without the intermediate colors normally present when an aqueous solution of the bromocresol green is used.

In general, dyes may be selected from those sensitive to volatile amine compounds found in tobacco and marijuana smoke. In an exemplary embodiment, the detection material comprises at least one dye which undergoes a color change in presence of HCN, NH₃, H₂S or Nicotine, or a combination thereof. In an exemplary embodiment, at least one dye undergoes a color change in presence of compounds found in tobacco or marijuana smoke, but no color change in the presence of smoke from wood burning or common household cleaners not containing ammonia. In an exemplary embodiment, the dye doped gel will not react with the components of most household aerosols that are ammonia-free. Accordingly, the choice of dye in the exemplary embodiments provides the advantage of determining with added certainty the presence of tobacco or marijuana smoke without false positives.

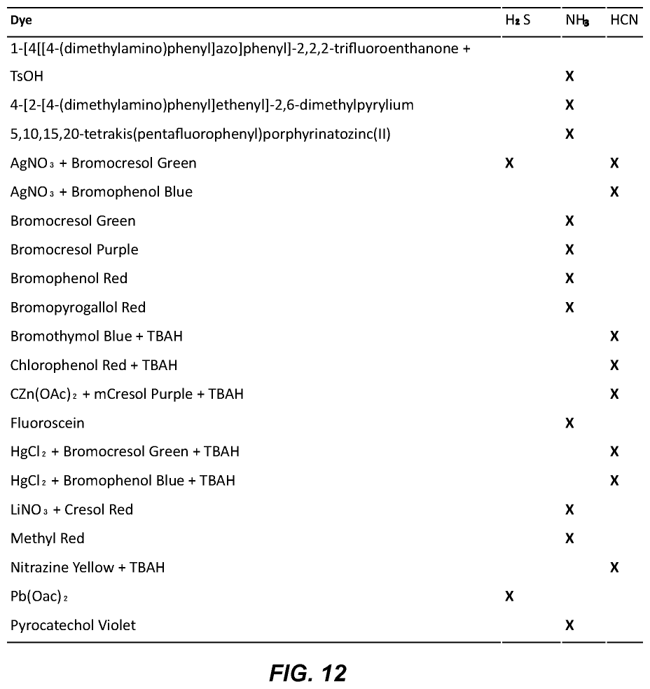

The present disclosure essentially contemplates incorporation of any dye capable of producing a color change in the presence of tobacco and marijuana smoke, including but not limited to, commercially available dyes and similar dyes with functional group substitution(s). A non-limiting list of commercially available dyes are provided in the table shown in FIG. 12. In an exemplary embodiment, the detection material comprises a porous silica gel and a dye selected from the group consisting of iodophenol blue, bromocresol green, bromocresol purple and bromophenol blue. In particular, derivatives of iodophenol blue, bromocresol green, bromocresol purple bromophenol blue are further contemplated herein. Of course, multiple dyes may be used in a single detector apparatus. For instance, given the different pH range of each dye, one or more color changes may indicate the increased presence of tobacco or marijuana smoke in an occupiable space.

Tobacco or marijuana smoke can contain radioactive Polonium-210. Therefore, it is further contemplated herein that a smoke detector comprises at least one dye reactive to Polonium-210 to undergo a separate color indication. Accordingly, the detector may undergo two separate color changes, one for HCN, NH₃, H₂S or Nicotine and another for elemental Polonium-210, thereby providing a yet higher degree of certainty of the presence of tobacco or cigarette smoke.

As introduced earlier, commercially available dyes include those provided in FIG. 12. In accordance with the present disclosure, such dyes may be buffered at a desired pH in the dye-doped sol gels to provide better color indication. Advantageously, the dyes can be selected to provide for a more intense and instantaneous color change in the presence of an increase in cigarette or tobacco smoke. Moreover, experimental results appear to show slight shift toward more basic pH for certain pH indicator dyes when exposed to cigarette smoke. Accordingly, in exemplary embodiments the dyes selected are buffered to a pH slightly below the maximum color transition of the dye to increase the magnitude of the color change. In one particular example, the dye is buffered at a pH of about 4.6.

As mentioned previously, a detector may comprise a plurality of detection elements. As such, a detector in accordance with an exemplary embodiment, comprises an array of indicator elements, each with different detector materials. Thus, the detector is capable of producing an array of color changes which can be interpreted as the presence of certain types of compounds that are found in tobacco or tobacco smoke. This colorimetric sensor array can be used to detect a wide range of volatile organic compounds such as those found in tobacco or marijuana cigarettes.

The present disclosure further contemplates a kit comprising an enclosure and at least one detection element. The enclosure can comprise one or more reaction compartments. The reaction compartment(s) can be configured to receive at least one detection element. The kit can comprise a plurality of detection elements, where each detection element comprises a detection material and a detection material backing configured to retain the detection material. The detection elements may be provided in a stacked form. Each detection element may further comprise a preservation layer to prolong the lifetime of each detection element. The detection material is configured to react with at least one component of tobacco smoke, to undergo a color change that is visible to an unaided human eye from a viewpoint 162 outside of the enclosure 102.

In the exemplary embodiments, the detection material 112 may be prepared by mixing a metal oxide monomer with a dye in presence of a solvent to form a gel. For example, after a silicate monomer is combined with a dye producing the “sol” or solvent phases, the solution is then reacted to slowly build the matrix forming a wet gel, and subsequently dried to form the porous dry gel. After drying the gel, the dye remains in the pores of the material. Suitable metal oxides monomers include those which permit gelation and mixing with the selected dye. In general, tetraalkoxymetal oxides such as tetraethoxysilicates are preferable as monomers. Following gelation and drying, the detection material may be aged by heating.

The following non-limiting examples illustrate preparation of detection materials using bromocresol green, bromocresol purple and bromophenol blue dyes. The exact amounts of reagents and solvents provided in the examples are not necessary for preparing a detection material. A person skilled in the art may vary the amounts of each of the listed solvents and reagents listed, as needed.

### WORKING EXAMPLE 1

### Bromocresol Green Doped Silica Gel

287 g of tetraethoxy silicate, 126 g of ethanol, 50 mL of deionized water, and 825 mg of bromocresol green powder are stirred in a 1 L Erlenmeyer flask. To this slurry 0.220 mL of 1M hydrochloric acid is added dropwise. The cloudy slurry is allowed to clear and is stirred overnight to ensure complete reaction. The reaction is conveniently carried out at room temperature and open atmosphere forming a clear orange solution of sol gel which may be deposited and dried to form a clear glass-like film on a surface, dried and powered, or retained in solution form.

### WORKING EXAMPLE 2

### Bromocresol Purple Doped Silica Gel

287 g of tetraethoxy silicate, 126 g of ethanol, 50 mL of deionized water, and 825 mg bromocresol purple are stirred in a 1 L Erlenmeyer flask. To this slurry 0.220 mL of 1M hydrochloric acid is added dropwise. The cloudy slurry is allowed to clear and is stirred overnight to ensure complete reaction. The reaction is conveniently carried out at room temperature and open atmosphere forming a clear orange solution of sol gel which may be deposited and dried to form a clear glass-like film on a surface, dried and powered, or retained in solution form.

### WORKING EXAMPLE 3

### Bromophenol Blue Doped Silica Gel

287 g of tetraethoxy silicate, 126 of ethanol, 50 mL of deionized water, and 825 g bromophenol blue are stirred in a 1 L Erlenmeyer flask. To this slurry 0.220 mL of 1M hydrochloric acid is added dropwise. The cloudy slurry is allowed to clear and is stirred overnight to ensure complete reaction. The reaction is conveniently carried out at room temperature and open atmosphere forming a yellowish solution of sol gel which may be deposited and dried to form a clear glass-like film on a surface, dried and powered, or retained in solution form.

### WORKING EXAMPLE 4

### Iodophenol Blue Doped Silica Gl

A sol gel containing the dye iodophenol blue (IPB) is prepared by mixing 2.1 g tetraethoxyorthosilicate, 0.5 mL of distilled water, 1.8 mL of 95% ethanol, and 10 mg of solid IPB. The sol gel formation process can be initiated with 10 microliters of 1.0 M HCl. The liquid solvated sol gel can be obtained as a clear yellow solution which dries to a glassy brittle solid gel on smooth surfaces and incorporates uniformly and solidly into porous material. Silica plates can be neutralized with 5% solutions of triethylamine in ethylacetate when basic surfaces were desired.

### WORKING EXAMPLE 5

### Dye Doped Silica Gels

5.21 g of tetraethoxy silicate was added to three test tubes along with 2.9 mL of ethanol, 0.90 mL of deionized water, and a stir bar. A slurry was made with the dye compound by adding approximately 1550 mg of solid dye (bromocresol green, bromocresol purple, and bromophenol blue) to each individual test tube. It was ensured that the solution was supersaturated with dye yielding the opaque slurry. To begin hydrolysis and gel formation, 4 microliters of 1 M HCl was added to each test tube via a calibrated pipet, and the solutions were allowed to stir for 3 days. These wet gel stock solutions were spotted via fisher pipet onto an aluminum backed silica TLC plate yielding approximately 1 cm diameter spots. Individual doped gels were aged to allow the pores to vacate adhered solvent molecules. The samples were aged in an oven at 100° C. for at least 24 hours, and some were aged in a dark drawer at room temperature.

### WORKING EXAMPLE 6

### Exposure to Tobacco Smoke

A “smoke box” enclosure was fashioned from a 1.5 ft³ cardboard box. Doped silica gel samples prepared in accordance with example 4 were placed in the box. A hole was cut in the center of the box where a lit tobacco cigarette could be allowed to burn inside and smoke could be blown in. Slits were cut in the side of the box to allow even pressure flow of air as the smoke was blown in. The samples were exposed to the smoke from the tip of a burning tobacco cigarette for 3 minutes, removed and immediately photographed to for any observed for color change.

Observation of the samples resulted in the positive identification of color change for bromocresol green and bromocresol purple for both the oven and drawer aged samples. The yellow green color of the standard bromocresol green was determined to be significantly shifted to a blue-green color consistent with move toward the basic form of the compound. Additionally, bromocresol purple shifted from a strongly yellow color to a reddish yellow consistent with a significant yet incomplete shift toward the purple basic form of the compound. Bromophenol blue yielded no color change which is not unexpected since the blue color is already a basic form. If the dyes are buffered to slightly more acidic than their color transition point, they may elicit even greater response to the naked eye.

### WORKING EXAMPLE 7

### BCT and IPB Exposure to Ammonia-Based Glass Cleaner and Durability

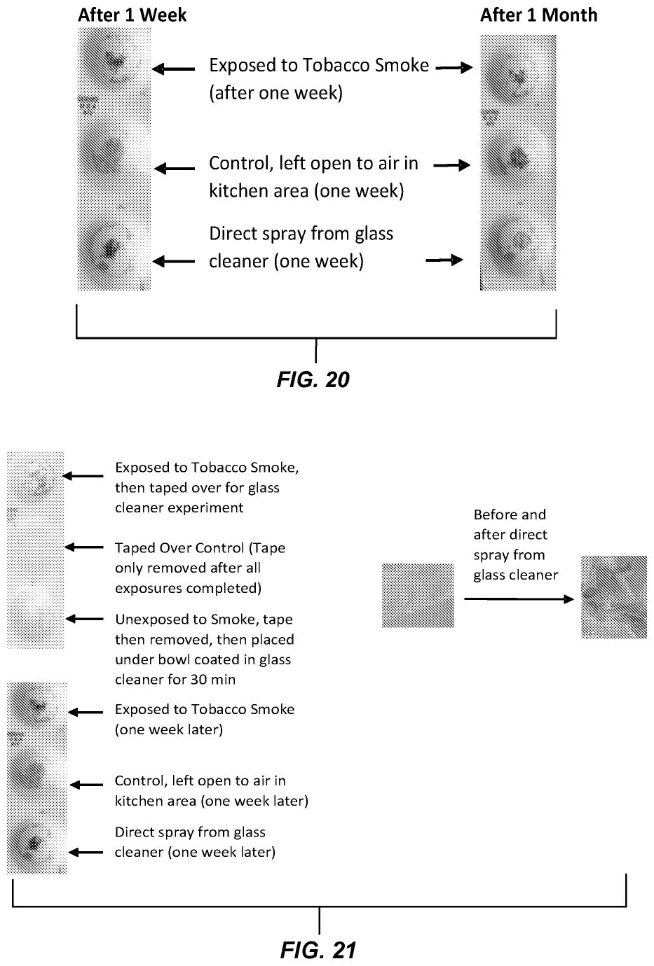

Smoke tests and controls were performed by allowing 0.25 mL of bromocresol green (BCG) and iodophenol blue (IPB) liquid gels to dry in a porcelain well plate. Smooth porcelain was used to reduce possibility of chemical contamination from plating material. In the case of bromophenol blue, a previously tested dye, atmospheric humidity can cause a color change without exposure to smoke. However, no false positive is observed due to atmospheric exposure with the BCG or new IPB gels after a one month period, as shown in FIG. 20. All controls and exposed gels were aged at least one week to one month to ensure permanence of the response.

For smoke exposure, red label cigarettes were allowed to burn with sufficient air flow with smoke traveling up into a bowl placed on a railing with the sensors flat on the rail to insure passing but indirect exposure to the burning cigarette itself. The cigarette was allowed to burn until it reaches about 25% its original length. As shown in FIG. 21, the sol gel material incorporating IPB produces a long-lasting yellow to violet color change which remains for at least one month.

The IPB gels were also exposed to vapors from ammonia-based glass cleaner. The results shown in FIG. 21 indicate that the unexposed IPB gel placed for 30 minutes under a bowl coated in class cleaner did not produce an observable color change. Although the IPB gel does not resist direct aqueous exposure to ammonia glass cleaner, this absence of acute sensitivity to ammonia vapors advantageously provides the potential for confidently detecting marijuana and cigarette smoke even when ammonia-containing products are used in the same environment.

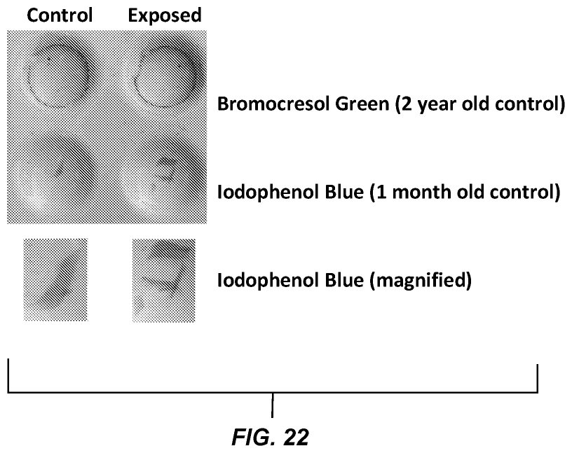

For durability, two year old BCG and one month old IPB gels were exposed to tobacco smoke. Both IPB and BCG gels exposed to smoke produced an observable color change in contrast with the control gels (see FIG. 22).

### WORKING EXAMPLE 6

### Stability of Doped Gels

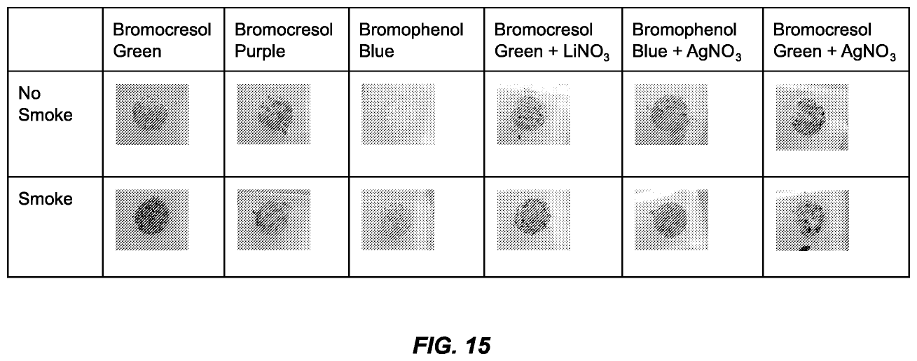

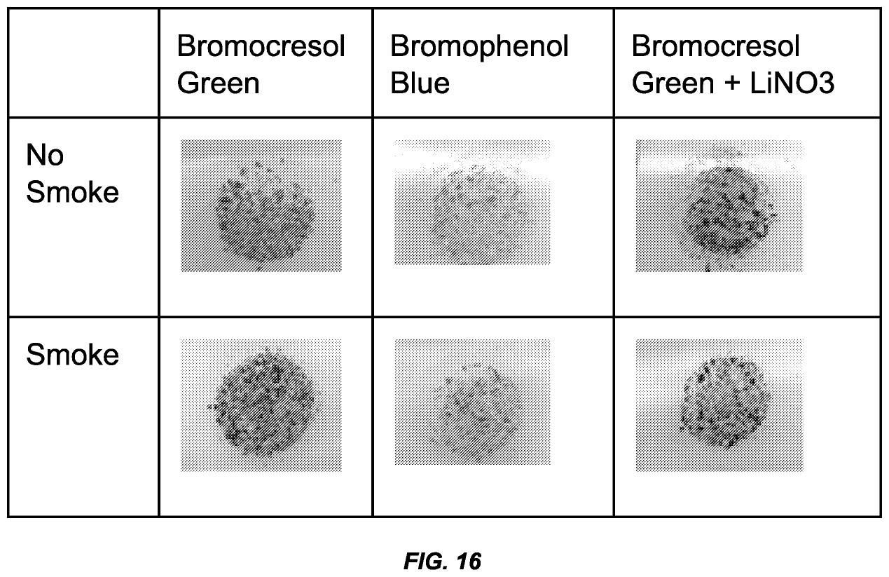

Stability of dried gels doped with different dyes (with or without metal), as shown in FIG. 15, were studied. Following exposure to tobacco cigarette smoke, the gels were aged in open air a household kitchen for a week. The results for smoked and non-smoked samples are shown in FIG. 16.

### WORKING EXAMPLE 7

### Selectivity of Doped Gels

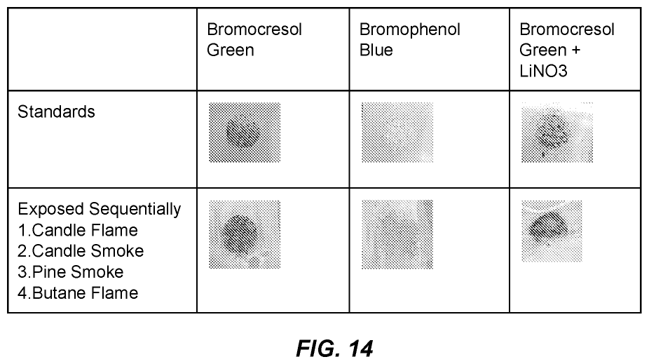

In addition to the successful colorimetric response to cigarette smoke, the doped gels also have proven selective against candle smoke, pine wood smoke, and butane lighter flame. Gels were sequentially exposed to volatile substances from candle flame, candle smoke, pine smoke and butane flame, commonly found indoors. The gels appeared to exhibit little to no observable change in color as seen in the table provided in FIG. 14.

### WORKING EXAMPLE 8

### Durability of Doped Gels

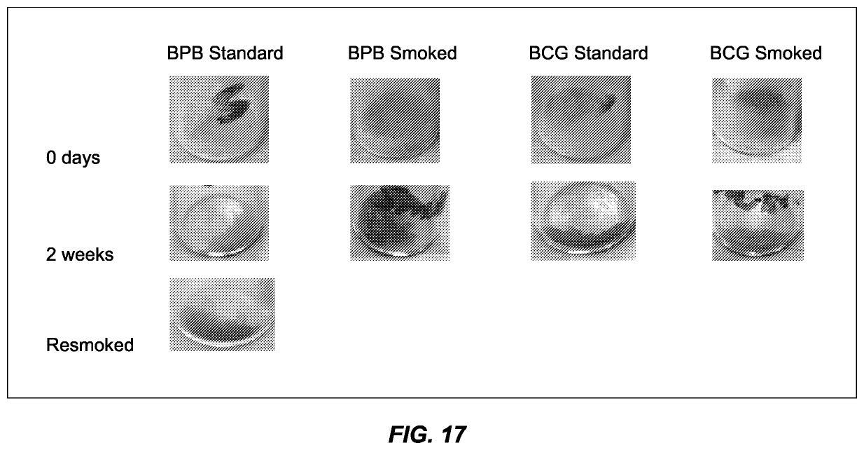

Bromomocresol green and Bromophenol blue doped gels were exposed to a temperature of 75° C. for a period of two weeks. The results are provided in FIG. 17. The bromophenol blue doped gels appeared to be robust at elevated temperature conditions. Not only did the standard appear to maintain its golden yellow color after 2 weeks of heating, but the standard seemed to remain sensitive to cigarette smoke even after the heating period. The smoked standard of the bromophenol blue doped gel appeared to darken from its original purple color yet maintain a distinct positive test. The bromocresol green doped gel appears to bind the dye reversibly at high temperature as the positive exposure of smoke causes a darkening to the color observed in the table, but this color is lost over the two-week period, suggesting that the bromocresol green doped gels do not perform optimally at elevated temperature applications. The doped silica gels when dried and ground into a fine powder appear to produce a more color-stable reference which can potentially widen the number of possible dye/metal combinations sensitive to tobacco or marijuana smoke.

### WORKING EXAMPLE 7

### Detection Material Backing

Stability of the doped gels in contact with different surfaces were studied by placing doped gels in contact with glass or porcelain surface and observed over a period of time. Bromocresol green and bromophenol blue gels were painted onto porcelain backing with a ‘watercolor’ brush. The orange color of bromocresol green appeared to retain from a period of over three months. Bromophenol blue appears to interact with atmospheric moisture to transition to a more purple color over the first 2 weeks. This may be due to the sensitivity given its lower transition pH. The porcelain plate (and doped gel) spent approximately one month in a kitchen, one month in a bath area, and one month outdoors. During the outdoor period it was exposed to direct sunlight, periods of >90° F., <40° F., wildfire smoke, and even rain, yet it appeared to retain its standard color. The gel transitions to blue after exposure to tobacco cigarette smoke.

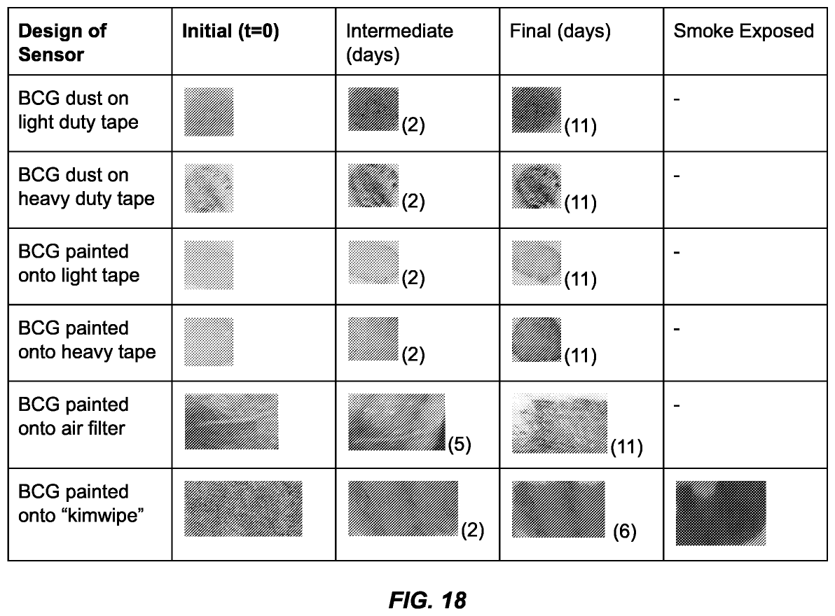

Doped gels were also tested by adhering them to other surfaces. It appears that the backing material of the sensors and method in which the gel is applied to the substrate (backing) affects the resting color of the gels over time. Here, the backing materials investigated included tape adhesives and filter papers through which air could be pulled to enhance exposure to smoke in a large room. The aging of gels backed with tapes (light duty and heavy duty) and papers (common 3M air filter and neutral laboratory wipe) is summarized in the FIG. 18.

The results suggest that adhering the powdered gels to tape results in a rapid transition to a dark color (the color change when using heavy duty tape is faster and more striking). Painting the gels onto tape results in a minimum color change for light duty tape but a striking change on the heavy-duty tape. The air filter paper and kim wipe samples begin to show a color transition. In particular, the color change of orange to a darker brown (green/orange mix) still occurs with the Bromocresol Green doped gels. It is possible that the tendency of these materials to change the color of the indicator depends upon the ability of the substrate to encourage water exchange with adhered gels and the inherent pH of the material. Silicates like the gel and porcelain are acidic to inert, and they can enhance the orange form of the dye and reduce interaction with atmospheric humidity. Bromophenol blue indicator is more sensitive to lower pH having a transition pH from about 3(yellow) to about 4.5(blue/purple); whereas bromocresol green transitions 3.8-5.6. Apparently, the bromophenol blue silicate equilibrates to a pH with atmospheric humidity or other factors in the transition range while bromocresol green does not. Thus, bromocresol green here might be a more preferred indicator, although bromophenol blue and other indicators may still work if proper buffering is performed on the substrate.

In the case of the tapes, the backing and adhesive have an affinity for moisture and a pH greater than sufficient to transition the gel color to a dark green which is an intermediate color for the titration of bromocresol green solution. Likewise, the pH of the papers is slightly acidic to neutral moving the color to a light green/brown such that the change to blue upon smoke exposure is still visibly recognizable (see FIG. 18). Thus, the choice of backing material may influence dye doped gel being used. Notably, the experimental results appear to suggest that it is advantageous, in exemplary sol gel dye systems disclosed herein, to mount the detection material on backings that preserve a low-pH environment, to improve the visibility of the color change. In the case of bromocresol green preferably, the interaction with humidity is minimized, and the pH kept below 4.

### WORKING EXAMPLE 8

### Sensitivity and Occupiable Space Size

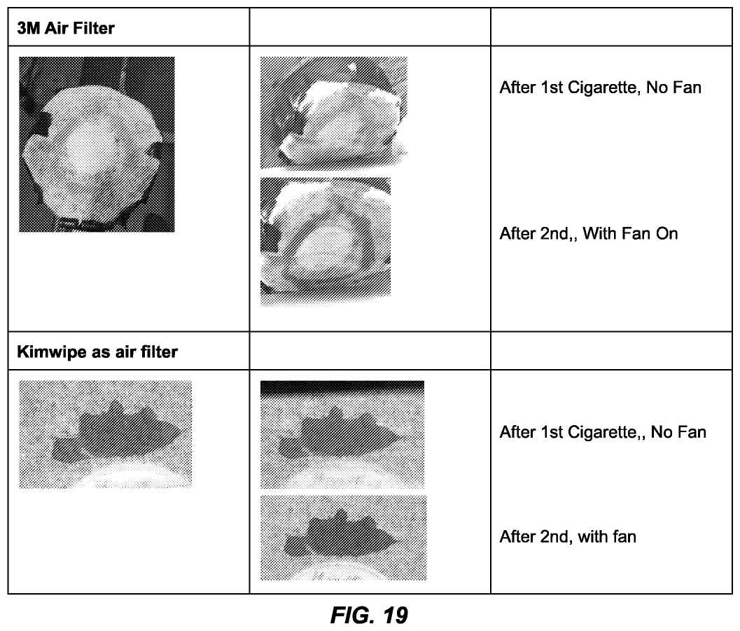

Doped gels adhered on porcelain and paper were smoke tested in an 8 ft×10 ft×8 ft room. The paper was wrapped around and adhered to a portable hand fan initially in the “off” position. The porcelain/doped gels were placed next to the fan and a Kidde brand smoke detector. The setup was centered with the 10-foot wall roughly 1 foot from the wall and 2 inches from the ceiling. A first cigarette was smoked in the center of the room from a seated position with the fan “off”. The second cigarette was then smoked with the fan on to simulate atypical air return or bathroom fan. 6 minutes was allowed after smoking before each photograph was obtained. It should be noted that in none of these tests did the functional Kidde smoke alarm sound as smoke in the ceiling area was diffuse and not visibly collecting. The results are summarized in the table provided in FIG. 19.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A smoke detection apparatus comprising:
an enclosure defining a reaction compartment therein; and
a detection element disposed within the reaction compartment, the detection element including a detection material comprising a porous gel material and a detection compound;
wherein the detection compound is configured to react with at least one component of tobacco smoke, and thereby undergo a color change visible to an unaided human eye from a viewpoint outward of the enclosure.

2-21. (canceled)

22. A smoke detection kit comprising:
an enclosure defining a reaction compartment therein; and
a multiplicity of detection elements, each of which
(a) is configured to be disposed within the reaction compartment,
(b) includes a detection material comprising a porous gel material and a detection compound;
wherein the detection compound is configured to react with at least one component of tobacco smoke, and thereby undergo a color change visible to an unaided human eye from a viewpoint outward of the enclosure.

23-24. (canceled)

25. A smoke detection kit as defined in claim 22, further comprising an auxiliary lens element, the auxiliary lens element including a magnification lens, a grip portion, and a lens support element disposed therebetween, the grip element being configured to engage the enclosure and suspend the lens therefrom at a fixed distance from the enclosure so as to optically magnify a detection element disposed within the reaction compartment from a viewpoint outward of the lens.

26. A smoke detection apparatus as defined in claim 1, wherein the detection material is configured to undergo a visible color change while placed in an occupiable space which comprises tobacco or marijuana smoke.

27. A smoke detection apparatus as defined in claim 1, wherein the detection compound is configured to react with at least one component of tobacco or marijuana smoke to undergo a color change that is visible to an unaided human eye from a viewpoint outward of the enclosure.

28-42. (canceled)

43. The smoke detection apparatus of claim 1, wherein the detection compound is capable of reversibly changing color in response to pH change.

44. The smoke detection apparatus of claim 1, wherein the detection compound is configured to change color upon reacting with one or more compounds in cigarette smoke.

45. The smoke detection apparatus of claim 1, wherein the detection compound is configured to change color upon reacting with HCN, NH3, H2S or Nicotine.

46. The smoke detection apparatus of claim 43, further comprising a second detection material configured to change color upon reacting with Polonium-210.

47. The smoke detection apparatus of claim 1, wherein the detection compound is configured to contact atmospheric moisture without changing color.

48-50. (canceled)

51. The smoke detection apparatus of claim 47, wherein the detection compound is a dye which changes color at a pH of about 4.6.

52. (canceled)

53. The smoke detection apparatus of claim 1, wherein the detection compound is configured to undergo a color change in the presence of volatile amine compounds in marijuana or tobacco smoke.

54-55. (canceled)

56. The smoke detection apparatus of claim 53, comprising a first detection material and second detection material, said first and second detection materials being distinct from one another, wherein the first detection material comprises a first detection compound configured to undergo a color change in the presence of volatile amine compounds and the second detection material comprises a second detection compound configured to undergo a color change in the presence of heavy metals.

57. The smoke detection apparatus of claim 56, wherein the color change of the first and second detection compounds are separately visible to an unaided human eye from a viewpoint outward of the enclosure.

58-101. (canceled)

102. A smoke detection element comprising:
a detection material; and
a detection material backing;
wherein the detection material comprises a detection compound located within the pores of a porous gel material,
wherein the detection compound is configured to react with at least one component of tobacco smoke or marijuana smoke, and thereby undergo a color change that is visible to an unaided human eye, and
wherein the detection material backing is configured to retain the detection material.

103. The smoke detection element of claim 102, wherein the detection material backing is buffered at a pH of about 3.5 or less.

104-106. (canceled)

107. The smoke detection element of claim 102, wherein the detection compound is a dye selected from the group consisting of iodophenol blue, bromocresol green, bromocresol purple and bromophenol blue.

108. The smoke detection element of claim 102, wherein the detection material is configured to be in contact with ammonia vapors or components of wood fire smoke without undergoing a color change.

109. (canceled)

110. The smoke detection element of claim 102, wherein the backing comprises a biodegradable material.

111-112. (canceled)

113. The smoke detection apparatus of claim 1, wherein the enclosure comprises a biodegradable material.

114-117. (canceled)

118. The smoke detection element of claim 102, wherein the detection compound is iodophenol blue.
